(19) United States
(12) Patent Application Publication
(10) Pub. No.: US 2011/0148052 A1
(43) Pub. Date: Jun. 23, 2011

(54) MECHANICAL DEVICE FOR TILT CONTROL

(75) Inventors: Jacques Quemere, Cadolive (FR); Jerome Gaillard-Groleas, Aix-en Provence (FR)

(73) Assignee: VELEANCE, Meyreuil (FR)

(21) Appl. No.: 13/054,881

(22) PCT Filed: Jul. 17, 2009
(86) PCT No.: PCT/FR09/00878

§ 371 Date: Mar. 2, 2011

(30) Foreign Application Priority Data
Jul. 21, 2008 (FR) 08/04137
May 12, 2009 (FR) 09/02271

(51) Int. Cl. B62K 5/04; B60G 21/00

(52) U.S. Cl. 280/6.15; 403/83

(57) ABSTRACT

The invention relates to a device that comprises:
a box 100;
a tilting frame 200; and
a passive joint 300 that enables tilting of the frame relative to the box; and
joint locking means 400.

The device further comprises:
an accelerometer (500) for measuring the transverse acceleration to which said tilting frame (200) is subjected; and
a control circuit for activating the locking means if the transverse acceleration exceeds a predetermined threshold.

The invention also relates to a vehicle, in particular a tricycle, provided with said device.

The present invention relates to a mechanical device for tilt control.

This device is for controlling the tilting of a mobile frame hinged to a box. This problem arises in particular in tricycles, the number of which is greatly increasing at the present time.

A tricycle essentially includes by way of a box an axle with two wheels, a frame one end of which supports the third wheel, and a joint that connects the other end of this frame to the axle.

In order to improve safety and comfort, it is known in the art to force the frame to tilt in turns.

Thus Document WO 2004/011324 proposes a tricycle in which tilting of the frame is driven by a double-acting actuator. One of the ends of this actuator is connected to the axle and the other to the tilting frame. The actuator is controlled as a function of the force exerted by the rider of the tricycle on a pedal-bar provided on the axle.

It is apparent that that tricycle does not provide the required safety in high-speed turns. Subjected to the centrifugal force essentially caused by the mass of the rider, the frame tends to tilt towards the outside of the turn.

Such a position of the frame makes riding the tricycle difficult or even dangerous. Moreover, the rider may force tilting of the frame in the wrong direction.

Document WO 2006/130007 describes a tricycle with motorized tilting controlled by a speed sensor, a direction sensor, and a lateral acceleration sensor. It is designed so that the lateral acceleration sensor predominates when stationary or at low speed whereas the direction sensor predominates at high speed. Once again, tilting of the frame is not really controlled at high speed.

Motorized tilting goes against the instincts of the rider, in that it imposes tilting rather than allowing free play to the physical phenomena of gravity and centrifugal force. Moreover, it consumes energy to tilt the frame, which is a considerable penalty for ecological vehicles of very low consumption, and appears inapplicable in practice to a human-propelled non-motorized vehicle. Moreover, the complete tilt control system is of some complexity, which is an undoubted handicap in terms of the cost of the vehicle.

Document FR 2 825 672 proposes a solution for limiting the risk of tilting in the wrong direction. The tricycle includes an axle disposed at the rear, a frame that supports the steerable front wheel, and a joint for connecting the frame to the axle. Here, however, the joint is passive, and the frame is free to tilt in response to the resultant of the forces applied to it. That tricycle further includes joint-locking means controlled by a pendular member. The aim is to prevent tilting of the frame when stationary or at very low speed and the mechanism is therefore deactivated as soon as the speed exceeds a predetermined threshold. The pendular member has a complex mechanical structure and can cause sudden locking of the frame.

Thus an object of the present invention is to provide a device suited to a non-motorized passive joint that makes it possible to control the tilting of the frame relative to the box when the speed is relatively high.

According to the invention, this device comprises:
a box;
a tilting frame;
a passive joint allowing tilting of said frame relative to said box; and
means for locking said joint;

the device being characterized in that it further comprises:
an accelerometer for measuring the transverse acceleration to which said tilting frame is subjected; and
a control circuit for activating said locking means if said transverse acceleration exceeds a predetermined threshold.

There is zero transverse acceleration when the frame is in dynamic equilibrium, whether the tricycle is moving in a straight line or around a curve. The term “dynamic equilibrium” is used to mean a tilting of the frame that corresponds to the resultant of radial acceleration and gravity. In contrast, this transverse acceleration increases as the frame departs from dynamic equilibrium in a curve. Thus the device of the invention prevents unwanted movement of the frame beyond a certain speed and optionally limits its tilting.

According to a first option, the locking means are arranged between the box and the tilting frame.

According to a second option, the box is deformable, and the device includes a reference rod, the locking means being arranged between that reference rod and the tilting frame.

According to a third option, the box again being deformable, the locking means are arranged between two elements of this box disposed on either side of the tilting frame.

For example, the box is of the superposed double-triangle type, and the locking means are arranged between an arm of an upper triangle and an arm of a lower triangle, these two triangles being disposed on either side of the tilting frame.

In a preferred embodiment the locking means comprise a double-acting actuator disposed between the box and the tilting frame.

The two chambers of the double-acting actuator are advantageously connected by two unidirectional pipes in opposite directions each including a valve.

Each of the unidirectional pipes includes a check valve, for example.

Alternatively, the two chambers of the double-acting actuator are connected by a single pipe including a single valve.

The control circuit is preferably adapted, if the transverse acceleration exceeds a predetermined threshold, to close that one of the valves that authorizes movement of the actuator in the direction of that acceleration.

Thus the frame is prevented from moving away from the dynamic equilibrium position but allowed to move towards it.

According to an additional feature of the invention, the control circuit is adapted to determine the opening of the valve as a function of the modulus of the transverse acceleration.

This feature makes it possible to ensure progressive locking of the joint, avoiding shocks or jerks.

Moreover, if the control circuit also has access to the longitudinal speed of the device, it is adapted to determine the opening of the valve as a function of the modulus of the longitudinal speed.

As a result, the device is practically inoperative at low speed.

Moreover, the control circuit is adapted to close the valve completely if the modulus of the longitudinal speed is in a predetermined range.

Moreover, the control circuit is adapted to open the two valves completely if the modulus of the longitudinal speed is zero or below a predetermined threshold.

According to another additional feature of the invention the control circuit includes a filter downstream of the accelerometer.

Here this filter is for filtering erratic movements of the tilting frame.

The device finds a particularly advantageous application in vehicles, notably tricycles.

The present invention now emerges in more detail from the following description of embodiments of the present invention given by way of example and with reference to the appended figures, in which:

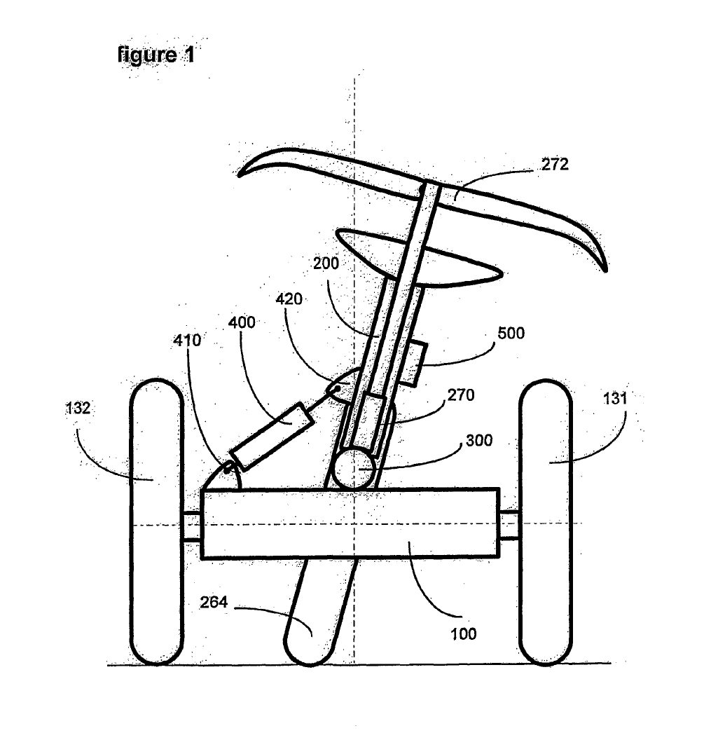

FIG. 1 is a diagrammatic front view of a rigid box tricycle equipped with a tilt device;

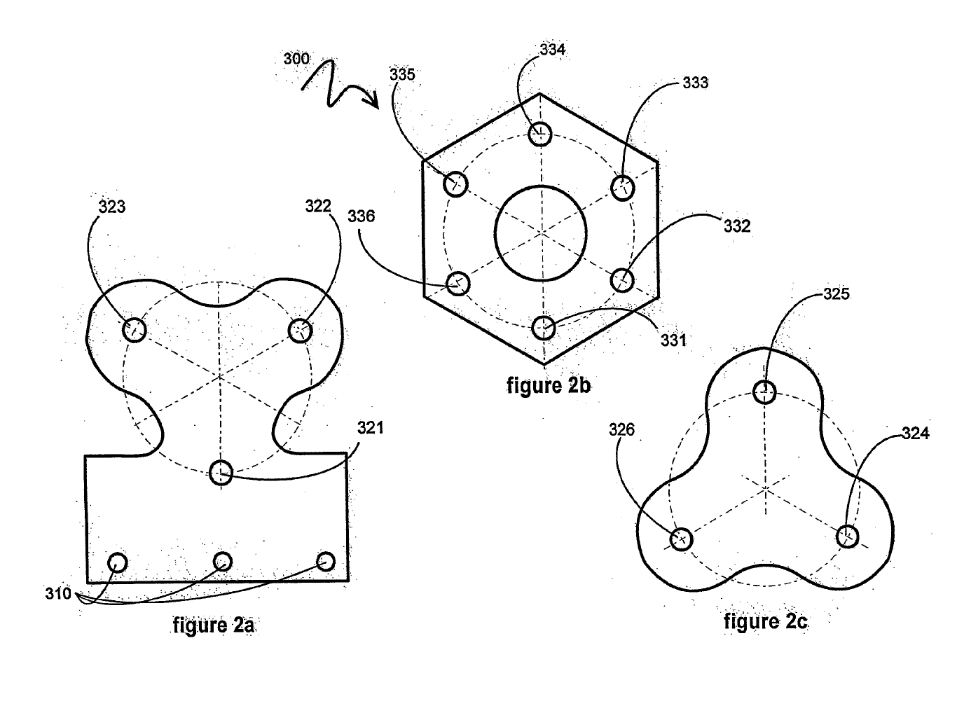

FIG. 2 is a diagram of a joint, and more precisely:

FIG. 2a is a view of a fastening lug;

FIG. 2b is a view of the joint;

FIG. 2c is a view of a fastening plate;

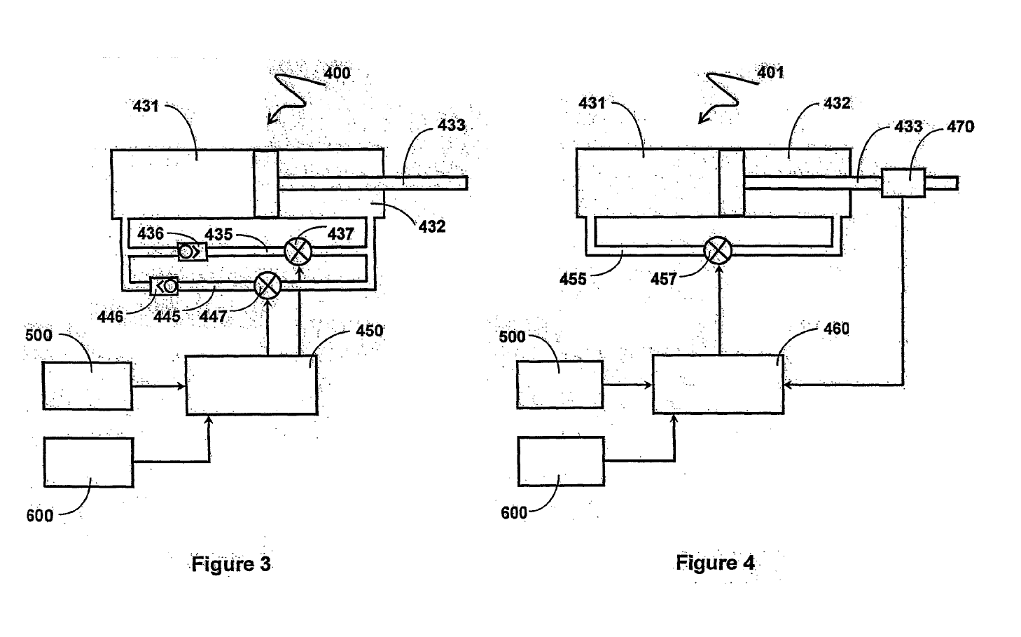

FIG. 3 is a diagram of locking means;

FIG. 4 shows a variant of the above locking means;

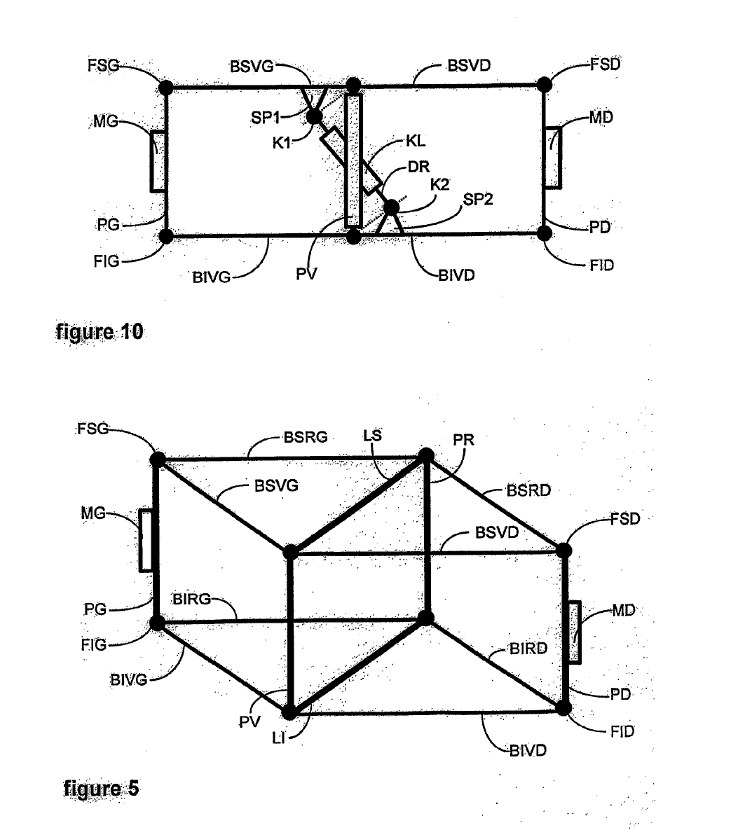

FIG. 5 is a three-quarter perspective view from the front of a deformable box;

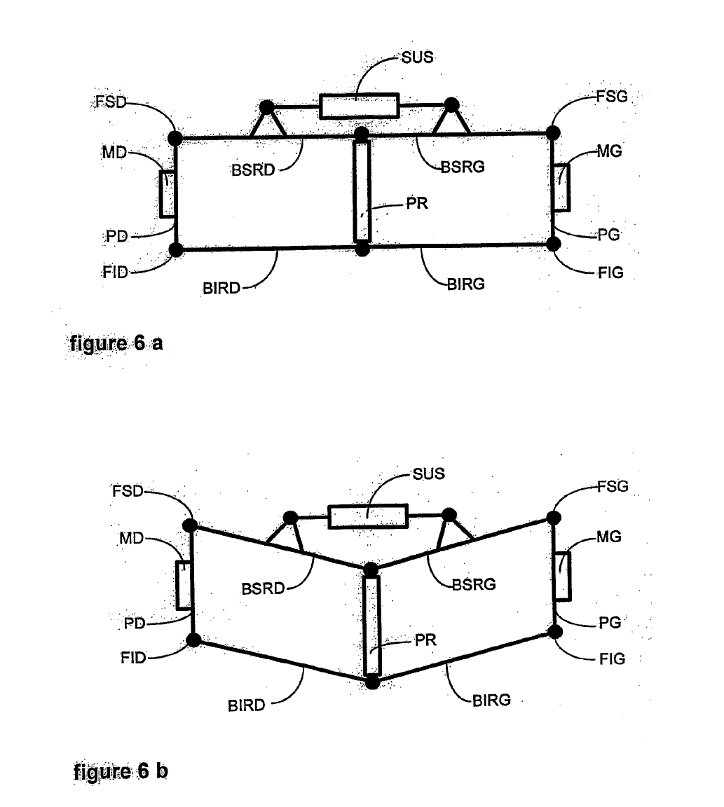

FIG. 6 is a diagram of this box seen from the rear, and more precisely:

FIG. 6a shows the box at rest;

FIG. 6b shows the box subjected to pumping;

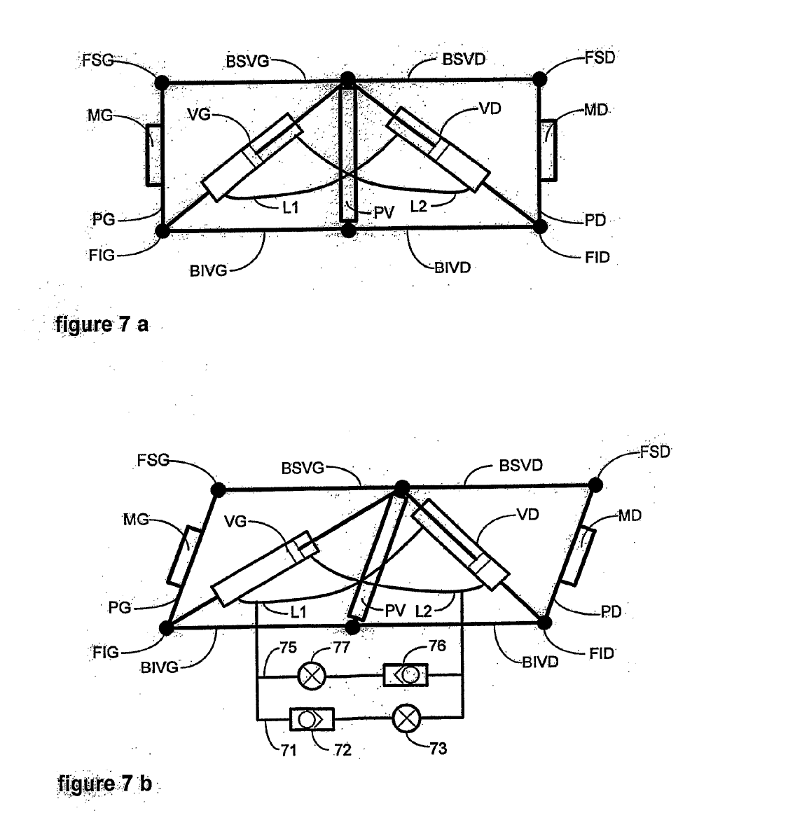

FIG. 7 is a diagram of a deformable box seen from the front, and more precisely:

FIG. 7a shows the frame vertical;

FIG. 7b shows the frame tilted;

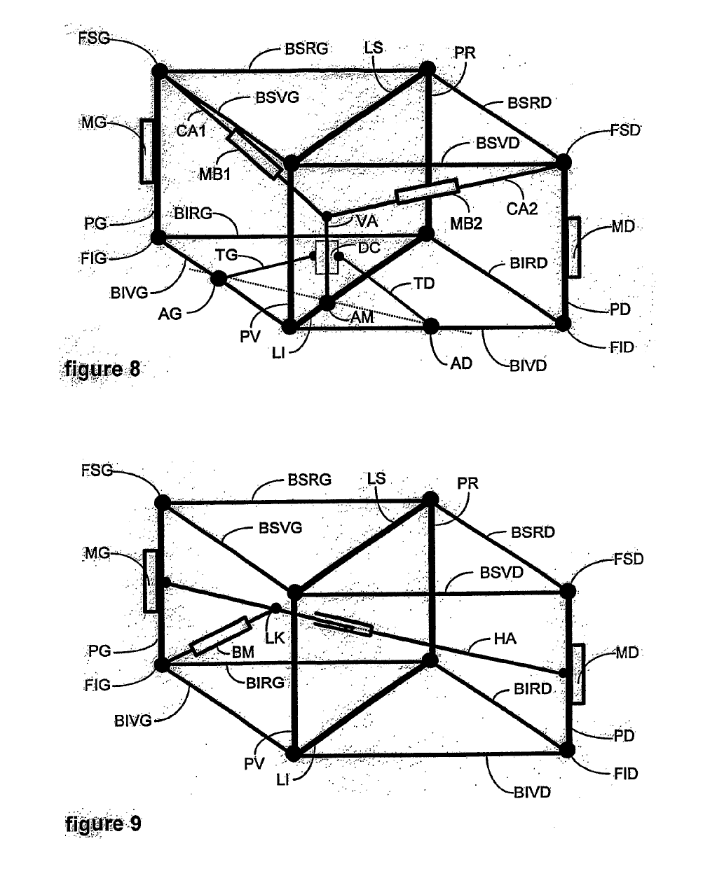

FIG. 8 is a diagrammatic three-quarter perspective view from the front of a deformable box having a vertical reference rod;

FIG. 9 is a diagrammatic three-quarter perspective view from the front of a deformable box having a horizontal reference rod; and

FIG. 10 is a diagrammatic front view of a deformable box.

Elements present in more than one of the figures are given the same references in each of them.

Referring to FIG. 1, a tricycle essentially comprises a steerable front axle 100, a tilting frame 200, and a joint 300 that allows the frame to tilt relative to the axle.

The axle 100 takes the form of a rectangular box that joins the left-hand front wheel 131 and the right-hand front wheel 132. The frame 200 is similar to that of a bicycle. The rear fork to which the rear wheel 264 is fastened is not seen. The steering tube 270 is arranged on the frame 200.

Locking means 400 are arranged between two anchor points, a first anchor point 410 attached to the box 100 and a second anchor point 420 attached to the frame 200. These anchor points allow pivoting of the ends of the locking means 400 so that their position is coordinated with that of the frame 200.

An accelerometer 500 is fastened to the frame 200 to measure the acceleration of this frame in the direction perpendicular to its plane. This accelerometer could be located elsewhere.

A preferred embodiment of the joint 300 is described in detail below with reference to FIG. 2.

In FIG. 2a, the fastening lug includes three holes 310 for fastening it to the support fastened to the axle 100. It also includes a first orifice 321, a second orifice 322, and a third orifice 323 spaced at 120° relative to the center of the circle on which they lie.

In FIG. 2b, a fastening plate 281 that is mounted at the end of the frame 200 includes a fourth orifice 324, a fifth orifice 325, and a sixth orifice 326 spaced at 120° relative to the center of circle on which they lie, this circle having the same diameter as the circle on which the three holes 321, 322, 323 of the fastening plate lie.

FIG. 2c shows the joint proper 300, which is a rubber spring member that has two substantially parallel faces. Here an aperture at its center increases its radial elasticity. It includes successively a first opening 331, a second opening 332, a third opening 333, a fourth opening 334, a fifth opening 335, and a sixth opening 336, which openings all open onto each of its two faces and the axes of which are perpendicular to those faces.

These six cylindrical openings are spaced at 60° relative to the center of the circle on which they lie, this circle having the same diameter as those on which lie the orifices 321, 322, 323 of the fastening lug and the orifices 324, 325, 326 of the fastening plate. By way of example, the joint 300 may be an elastic coupling sold under the registered trade mark JUBOFLEX by the company PAULSTRA, 61 rue Marius Aufan, 92305 Levallois-Perret, France.

The joint 300 is fastened to the fastening lug by means of three bolts, the first of which passes through the first orifice 321 and the first opening 331, the second of which passes through the second orifice 322 and the third opening 333, and the third of which passes through the third orifice 323 and the fifth opening 335. In a similar way, a fourth bolt passes through the fourth orifice 324 and the second opening 332, a fifth bolt passes through the fifth orifice 325 and the fourth opening 334, and a sixth bolt passes through the sixth orifice 326 and the sixth opening 336.

Many other joints may be envisaged. For example, an elastic joint may consist of an internal tube and an external tube, these two tubes being concentric and linked by a ring of elastomer or any other elastic material. The two members to be coupled are fastened one to the internal tube and the other to the external tube.

An important point is that the joint opposes relative rotation of the two elements that it joins. In other words, this joint must have resistance to rotation. Thus a simple cylindrical stud having some resilience fastened firstly to the fastening lug and secondly to the fastening plate may serve this purpose.

FIG. 3 shows a preferred embodiment of the locking member 400. It consists of a double-acting actuator the first chamber 431 of which is at the same end as the box 100 and the second chamber 432 and the piston rod 433 of which are at the same end as the frame 200.

A first pipe 435 allows fluid to flow only from the first chamber 431 to the second chamber 432. Similarly, a second pipe 445 allows fluid to flow only from the second chamber 432 to the first chamber 431.

The first pipe 435, respectively the second pipe 445, includes a first check valve 436, respectively a second check valve 446, to ensure one-way fluid flow. Moreover, the first pipe 435, respectively the second pipe 445, includes a first valve 437, respectively a second valve 447.

A control circuit 450 such as a microcontroller controls the valves in response to the output signal from the accelerometer, which measures transverse acceleration of the frame in the direction perpendicular to its plane.

When the frame is in dynamic equilibrium, i.e. when there is zero transverse acceleration, the microcontroller 450 commands opening of the valves.

If the modulus of the transverse acceleration exceeds a predetermined threshold, two situations may arise.

If this acceleration is positive, i.e. if the frame is tilted too far relative to the equilibrium position, in the situation of a turn to the left the control circuit 450 commands closing of the second valve 447 and leaves the first valve 437 open. Thus the actuator can no longer extend but can retract. Naturally, in the situation of a turn to the right, the two valves 437, 447 are commanded oppositely to the above.

If on the contrary the frame 200 is insufficiently tilted relative to the equilibrium position, the control circuit 450 commands closing of the first valve 437 and leaves the second valve 447 open. Thus the actuator can extend but cannot retract.

To obtain smooth operation of the locking means and to prevent excessively brutal braking of the frame, the two valves 437, 447 do not operate on an on/off basis but rather feature a variable flow aperture. The control circuit 450 determines the flow apertures of these valves as a function of the modulus of the transverse acceleration. This function is linear, for example, total closure of the valve being commanded by an acceleration equal to or greater than a fixed value.

It should be noted that a two-axis accelerometer may be used, with both axes in a plane perpendicular to the frame 200, one in the plane of the frame and the other perpendicular to the frame.

The angle of the acceleration vector in the system of mutually perpendicular axes defined by the two axes of the sensor thus reflects directly the angular offset relative to the dynamic equilibrium position. This angular offset may serve as a reference for the control circuit 450 instead of the modulus of the transverse acceleration, constituting equivalent means.

In an ancillary manner, a speed sensor 600 supplies the longitudinal speed of the device to the control circuit 450. This disables the locking means, i.e. leaves both valves 437, 447 completely open, when this speed is zero or very low. This prevents opposition to erratic movements of the frame, notably when starting the vehicle.

It is also possible to lock the frame against tilting, for example on rough terrain. To this end information is sent to the control circuit for 450 so that it commands total closing of both valves 437, 447.

It is also preferable to provide a filter in the control circuit 450 to prevent unwanted operation of the valves 437, 447 in response to erratic transverse acceleration. This minimizes the effect of vibrations or sharp road features. This filter, which is a low-pass filter, for example, is placed at the output of the accelerometer 500. It also filters transient regimes that occur notably at low speed or on entering or leaving a turn; operation is stabilized by preventing hunting.

The locking means described above have the advantage of very low energy consumption because the only active elements are the valves 437, 447.

A variant 401 of the locking means, again in the hydraulic field, is described below with reference to FIG. 4.

The same double-acting actuator is used with its two chambers 431, 432, and its piston rod 433. Now a single pipe 455 enables the fluid to flow only from the first chamber 431 to the second chamber 432 or only from the second chamber 432 to the first chamber 431, as appropriate. This pipe includes a single solenoid valve 457.

A force sensor 470 such as a strain gauge is arranged on the piston rod 433 of the actuator to measure the longitudinal force to which this rod is subjected.

A microprocessor 460 controls the solenoid valve 457 in response to the output signal of the force sensor 470.

The microcontroller 450 commands opening of the solenoid valve when the frame is in dynamic equilibrium, i.e. when there is no transverse acceleration. It does likewise if the combination of the output signals of the force sensor 470 and the accelerometer 500 indicates that the frame is approaching dynamic equilibrium. In contrast, it commands closure of the solenoid valve 457 if the combination of the output signals of the force sensor 470 and the accelerometer 500 indicates that the frame is moving away from dynamic equilibrium.

Still in the hydraulic field, the use of a magneto-rheological actuator may be envisaged. The fluid circulating in such an actuator is charged with ferromagnetic particles so that its viscosity is a function of the magnetic field to which it is subjected. Thus the resistance to the flow of the fluid may be varied using an electromagnet.

The invention nevertheless applies to any other embodiment of the locking means provided that their function is to control the tilting of a frame 200.

For example, an electrically controlled brake of the clutch type may be provided on the axis of the joint 300, this brake taking the form of two concentric disks the axis of which coincides with that of this joint.

Other solutions are equally available to the person skilled in the art. It suffices to adapt the control arrangements in the light of the teaching of the present invention.

Independently of the locking means, it may be judicious to limit tilting of the frame 200 by means of mechanical stops (not shown), typically in a range from −30° to +30°.

It is thus apparent that the invention applies whether the box is rigid or deformable.

FIG. 5 shows by way of example a force diagram of an independent suspension comprising superposed double triangles.

The box is hinged to a rigid framework that constitutes an extension of the tilting frame and is thus coplanar with it. The tilting frame is not represented because it is identical to that described above. Thus this framework is considered an integral part of the frame.

The framework has a rectangular structure that includes an upper longitudinal member LS, a lower longitudinal member LI, a rear beam PR that joins the two longitudinal members at the frame end, and a front beam PV that joins them at the opposite end, i.e. at the front of the vehicle.

A right-hand upper triangle that has for its base the upper longitudinal member LS includes a right-hand front upper arm BSVD and a right-hand rear upper arm BSRD, these two arms being connected to a right-hand upper fastening point FSD.

A right-hand lower triangle that has for its base the lower longitudinal member LI includes a right-hand front lower arm BIVD and a right-hand rear lower arm BIRD, these two arms being connected to a right-hand lower fastening point FID.

A right-hand beam PD is arranged between the right-hand upper fastening point FSD and the right-hand lower fastening point FID. This beam supports the right-hand hub MD.

The arms are naturally hinged to the framework and to the right-hand beam.

A left-hand upper triangle that has for its base the upper longitudinal member LS includes a left-hand front upper arm BSVG and a left-hand rear upper arm BSRG, these two arms being connected to a left-hand upper fastening point FSG.

A left-hand lower triangle that has for its base the lower longitudinal member LI includes a left-hand front lower arm BIVG and a left-hand rear lower arm BIRG, these two arms being connected to a left-hand lower fastening point FIG.

A left-hand beam PG is arranged between the left-hand upper fastening point FSG and the left-hand lower fastening point FIG. This beam supports the left-hand hub MG.

The arms are naturally hinged to the framework and to the left-hand beam.

In FIG. 6a, the box is shown at rest from the rear. A suspension member SUS (not shown in FIG. 5) is hinged between the right-hand rear upper arm BSRD and the left-hand rear upper arm BSRG. This suspension member SUS is a combined spring-damper.

Thus the box includes two deformable parallelograms. A left-hand rear parallelogram is formed by the left-hand rear upper arm BSRG, the left-hand beam PG, the left-hand rear lower arm BIRG, and the rear beam PR. A right-hand rear parallelogram is formed by the right-hand rear upper arm BSRF, the right-hand beam PD, the right-hand lower arm BIRD, and the rear beam PR.

In FIG. 6b, which is homologous to FIG. 6a, the box is seen from the same angle when subjected to a symmetrical deformation known as pumping.

FIG. 7a shows the box at rest as seen from the front.

The box thus again includes two deformable parallelograms. A left-hand front parallelogram is formed by the left-hand front upper arm BSVG, the left-hand beam PG, the left-hand front lower arm BIVG, and the front beam PV. The right-hand front parallelogram is formed by the right-hand front upper arm BSVD, the right-hand beam PD, the right-hand lower arm BIVD, and the front beam PV.

Locking means are again arranged between the box and the frame. They comprise a left-hand module VG and a right-hand module VD symmetrically disposed in the two front parallelograms.

The left-hand module VG is arranged on the diagonal of the left-hand front parallelogram the origin of which is the left-hand lower fastening point FIG.

The right-hand module VD is arranged on the diagonal of the right-hand front parallelogram the origin of which is the right-hand lower fastening point FID.

Here both modules VG, VD are double-acting actuators. Depending on how they are controlled, they may operate on pumping and/or tilting of the frame.

In the situation of pumping with zero tilt, the two actuators extend or retract simultaneously in the same proportions.

By connecting the opposite chambers of the two actuators, pumping is active only in damping, which may be controlled by acting on the section of the pipes that connect the two actuators MD, MG. It follows that the damping function of the suspension member SUS may be omitted, the suspension then being reduced to a spring.

In contrast, in this configuration, tilting of the frame is prevented because the chambers of the actuators that are connected are subjected simultaneously either to an increased pressure or to a reduced pressure.

Referring to FIG. 7b, the tilting of the frame may nevertheless be controlled. A first conduit 71 allows fluid to flow only from the first line L1 to the second line L2. Likewise, a second conduit 75 allows fluid to flow only from the second line L2 to the first line L1.

The first conduit 71, respectively the second conduit 75, includes a first check valve 72, respectively a second check valve 74, to ensure one-way movement of the fluid. Moreover, the first conduit 71, respectively the second conduit 75, includes a first valve 73, respectively a second valve 77.

It is prudent to provide a compensation reservoir (not shown) in the hydraulic circuit to overcome any lack of symmetry, this being standard practice for the person skilled in the art.

The valves are controlled in a similar manner to that described with reference to FIG. 3, to damp, brake or lock tilting of the frame.

Although the box is deformable, this amounts to the same thing as a rigid box as the locking means are anchored to fixed points of this box, namely the left-hand lower fastening point FIG and the right-hand lower fastening point FID.

This is not obligatory, however.

Other solutions may lead to improved decoupling between suspension and tilt control.

A first solution defines a reference axis that is immobile both when pumping and when tilting the frame. A reference is required for estimating the tilt.

Referring to FIG. 8, a vertical reference rod is defined. This rod is vertical when the plane on which the wheels bear is horizontal. Thus here vertical means orthogonal to the axis of the wheels.

To this end, there are a left-hand anchor point AG on the left-hand front lower arm BIVG, a right-hand anchor point AD on the right-hand front lower arm BIVD, and a median anchor point AM on the lower longitudinal member LI. These three anchor points AG, AD, AM are in the same vertical plane and the left-hand anchor point AG and the right-hand anchor point AD are equidistant from the lower longitudinal member LI.

A vertical rod VA is hinged at its first end to the median anchor point AM and at its second end to a control rod CA that is hinged to the left-hand upper fastening point FSG.

A sliding bush DC is mounted on the vertical rod VA.

A left-hand crossmember TG is hinged firstly to the left-hand anchor point AG and secondly to this bush DC. Similarly, a crossmember TD is hinged firstly to the right-hand anchor point AD and secondly to the bush DC. The two crossmembers TG, TD are the same length so that, given that the three anchor points AG, AD, AM are coplanar, the vertical rod is effectively perpendicular to the axis of the wheels at all times.

First locking means MB1 are provided here on the control rod CA1 that connects a first left-hand upper fastening point FSG to the top of the vertical rod VA. Thus any tilting induces a variation in the length of the control rod CA, and this tilting may be controlled as explained above.

The arrangement may be made symmetrical by providing a second control rod CA2 on which second locking means MB2 are mounted. This second control rod CA2 is hinged between the top of the vertical rod VA and the right-hand upper fastening point FSD.

Referring to FIG. 9, a horizontal reference axis is defined. By horizontal is meant co-linear with the axis of the wheels. If the tilt can be estimated with reference to the vertical, it can also be estimated with reference to the horizontal. This horizontal rod HA is hinged between the left-hand beam PG and the right-hand beam PD. It is telescopic to accommodate the variation in the distance between these two beams caused by pumping. For example, the right-hand section of this rod HA is provided with a sleeve at its end opposite that which lies on the right-hand beam PD. The left-hand section of this rod HA takes the form of a rod the end of which opposite that which lies on the left-hand beam PG slides in this sleeve. The horizontal rod HA is naturally perpendicular to the rigid framework LS, PR, LI, PV.

Here the locking means BM are seen on a rod hinged between the left-hand lower fastening point FIG and an attachment point LK disposed on the right-hand section of the horizontal rod HA.

It is thus apparent that the tilt of the frame may be estimated relative to the vertical or the horizontal. It follows that it may be estimated with reference to any fixed axis orthogonal to this frame.

The tilt may equally be controlled with reference to two deformable box elements that are subjected to opposite movements.

Referring to FIG. 10, the box is again seen from the front. The locking means KL are now arranged on a rod DR hinged between a first connecting point K1 and a second connecting point K2. The first connecting point K1 lies at the top of a first support SP1 fastened under the left-hand front upper arm BSVG.

The second connecting point K2 at the top of a second support SP2 is fastened to the right-hand front lower arm BIVD. The connecting points K1, K2 are equidistant as much from the front beam PV as from the respective arms to which they are attached. They are thus disposed so that the right-hand segments that connect them to the upper longitudinal member are orthogonal to the rod DR. This arrangement makes it possible to increase the decoupling between suspension and tilt control.

To a first order, the distance between the two connecting points K1, K2 is practically invariant in the event of pumping whereas it is significantly modified in the event of substantial tilting.

It is worth repeating that in the situation generally referred to in the present document in which the locking means KL comprise a double-acting actuator, which actuator is again controlled as explained with reference to FIG. 3.

It should also be remembered that, as in the situation of a fixed box, the locking means are not limited to the actuator alone and may also take any form here, such as a brake. For example, this brake is either in the joint that lies between the tilting frame and the reference axis or between two elements of the deformable box subjected to opposite movements.

The embodiments of the invention described above have been chosen for their concrete nature. However, it would be impossible to list exhaustively all embodiments of this invention. In particular, any means described may be replaced by equivalent means without departing from the scope of the present invention.

1. A device comprising:
a box (100; PG-PD);
a tilting frame (200; PV-PR);
a passive joint (300; BIRG-BIRD) allowing tilting of said frame relative to said box; and
means (400, MG, MD, MB1, MB2, BM, KL) for locking said joint;
the device being characterized in that it further comprises:
an accelerometer (500) for measuring the transverse acceleration to which said tilting frame (200; PV-PR) is subjected; and
a control circuit (450) for activating said locking means if said transverse acceleration exceeds a predetermined threshold.

2. A device according to claim 1, characterized in that said locking means (400, MG, MD) are arranged between the box (100; PG-PD) and said tilting frame (200; PV-PR).

3. A device according to claim 1, characterized in that said box (PG-PD) is deformable, and the device includes a reference rod (VA; HA), said locking means (MB1, MB2; BM) being arranged between that reference rod and said tilting frame (PV-PR).

4. A device according to claim 1, characterized in that, said box (PG-PD) is deformable, and said locking means (KL) are arranged between two elements (BSVG, BIVD) of this box disposed at either end of said tilting frame (PV-PR).

5. A device according to claim 4, characterized in that, said box (PG-PD) is of the superposed double-triangle type, and said locking means (KL) are arranged between an arm (BSVG) of an upper triangle and an arm (BIVD) of a lower triangle, these two triangles being disposed at either end of said tilting frame (PV-PR).

6. A device according to claim 1, characterized in that said locking means comprise a double-acting actuator (400, 401, MG, MD, MB1, MB2, BM, KL).

7. A device according to claim 6, characterized in that the two chambers (431, 432) of said double-acting actuator (400) are connected by two unidirectional pipes (435, 445) in opposite directions each including a valve (437, 447).

8. A device according to claim 7, characterized in that each of said unidirectional pipes (435, 445) includes a check valve (436, 446).

9. A device according to claim 3, characterized in that the two chambers (431, 432) of said double-acting actuator (401) are connected by a single pipe (455) including a single valve (457).

10. A device according to claim 6, characterized in that said control circuit (450) is adapted, if said transverse acceleration exceeds a predetermined threshold, to close that one of said valves (437, 447, 457) that authorizes movement of said actuator (400, 401) in the direction of that acceleration.

11. A device according to claim 10, characterized in that said control circuit (450) is adapted to determine the opening of said valve (437, 447, 457) as a function of the modulus of said transverse acceleration.

12. A device according to claim 11, characterized in that, said control circuit (450) also having access to the longitudinal speed (600) of the device, it is adapted to determine the opening of said valve (437, 447, 457) as a function of the modulus of said longitudinal speed.

13. A device according to claim 12, characterized in that said control circuit (450) is adapted to close said valve (437, 447, 457) completely if the modulus of said longitudinal speed is in a predetermined range.

14. A device according to claim 12, characterized in that said control circuit (450) is adapted to open the valve or valves (437, 447, 457) completely if the modulus of said longitudinal speed is zero or below a predetermined threshold.

15. A device according to claim 1, characterized in that said control circuit (450) includes a filter downstream of said accelerometer (500).

16. A vehicle equipped with a device according to claim 1.

17. A vehicle according to claim 12, characterized in that it is a tricycle.
